(19) United States
(12) Patent Application Publication
(10) Pub. No.: US 2013/0031763 A1
(43) Pub. Date: Feb. 7, 2013

(54) IMPACT SEPARATOR TOOL

(71) Applicant: Roger Kliskey, Brimfield, OH (US)

(72) Inventor: Roger Kliskey, Brimfield, OH (US)

(21) Appl. No.: 13/196,029

(22) Filed: Aug. 2, 2011

(51) Int. Cl. B25B 27/02; B23P 11/00

(52) U.S. Cl. 29/426.6; 29/254

(57) ABSTRACT

An impact separator tool is useful for separating a tie rod end from a steering knuckle and includes a housing, a ram bar, and a working tool. The working tool may be a floating pickle fork assembly that is moveable with respect to the housing. A retainer pin extends through the housing and the pickle fork, and limits the movement of the pickle fork with respect to the housing.

### FIELD OF THE INVENTION

This invention relates to an impact separator tool. More particularly, this invention relates to an impact separator tool that is useful for separating components that are mechanically connected, such as separating a tie rod end from a steering knuckle.

### BACKGROUND OF THE INVENTION

The steering and suspension systems of an automobile include several interconnected components. Two such components that are connected include a tie rod end and a steering knuckle. The tie rod end is positioned at and connected to the distal portion of a tie rod. The tie rod end includes a portion that attaches to the tie rod, as well as a ball joint. The ball joint includes a socket and a stud arrangement, and the stud extends from the socket and typically tapers radially inward towards its other end, giving a portion of the stud a generally frusto-conical shape. The steering knuckle attaches steering and suspension components to a wheel's support assembly, and allows the wheel to be turned left and right. The knuckle includes a bore for receiving the stud of the tie rod end. The tapered shape of the stud and the bore that receives it are generally complementary in shape, and as a result, the further the stud extends into the bore, the tighter and stronger the connection between the tie rod end and the steering knuckle. The stud of the tie rod end is generally made of metal, as is the portion of the steering knuckle that receives it. Other structure, such as nuts or pins, may be used to secure the connection between the stud of the tie rod end and the steering knuckle. Over time and after exposure to the elements, the connection between the stud and the bore can become weathered and characterized by corrosion, further contributing to the connection between the tie rod end and the steering knuckle.

Disconnecting a tie rod end from a steering knuckle may be necessary for repair or replacement, but doing so can be challenging. The tie rod stud and the steering knuckle may be firmly connected, and as discussed, their components can further grow together after exposure to the elements. Accordingly, substantial physical effort may be required to separate the two. A variety of tools and approaches have been used to separate a tie rod end from a steering knuckle.

For example, it is known to strike a steering knuckle with a hammer to loosen the connection with the tie rod end. This approach requires the user to strike the steering knuckle to create sufficient disruptive force to separate the two components. Striking the tie rod and the tie rod end is also known. However, this approach does not target the specific location of the connection between the tie rod end and the steering knuckle, and instead applies striking force indiscriminately to the tie rod end or steering knuckle, which can damage them or fail to separate the two components. Moreover, it requires substantial amount of room for a user to be able to draw the hammer back and swing it forward and generate sufficient force to separate the components. Another approach is where a user holds a hammer in one hand and a separating tool in another. Such separating tools are sometimes referred to in the art as pickle forks. A pickle fork includes a handle portion and a tined working portion. The working portion is placed between the ball joint of a tie rod end and the steering knuckle, and the user swings the hammer hitting the base portion of the handle of the pickle fork. This approach requires the user to have two tools, a pickle fork and a hammer, and to hold one tool in each hand. Each tool must be independently controlled, and this may be difficult for users who are not coordinated with one of their hands, or otherwise. It also requires enough room to fit both the separating tool and the hammer into the region of the connection. Another drawback of this approach is that users can inadvertently strike the hand holding the pickle fork instead of the base of the pickle fork, causing pain and damage to the user's hand, not to mention failing to separate the tie rod end from the steering knuckle. Other techniques, including prying are also known but are presently less favored by those skilled in the art.

Thus, the need exists for apparatus that are useful for separating components that are mechanically connected, such as removing tie rod ends from steering knuckles.

### SUMMARY OF THE INVENTION

In general, the present invention provides an improved impact separator tool useful for separating components that are mechanically connected, such as a tie rod end and a steering knuckle. The impact separator tool includes a ram bar that may be used to forcibly strike the top of the shaft of a separating tool such as, for example, a floating pickle fork such that the separating tool, e.g., the prongs of the pickle fork, may separate and disengage the mechanically connected items.

In accordance with at least one aspect of the present invention, the impact separator tool includes a housing including slots, a ram bar slidably receivable in the housing, and a working tool assembly operatively connected to the housing and having a through bore. The slots and the through bore are at least partially aligned and the working tool assembly is moveable with respect to the housing.

In accordance with at least one aspect of the present invention, a tool for separating a tie rod end from a steering knuckle includes a housing, a ram bar moveable within and slidably received within the housing, and a floating pickle fork assembly operatively connected to, and free to move with respect to, the housing.

In accordance with at least one aspect of the present invention a method for separating a tie rod end from a steering knuckle includes the steps of: positioning a tool comprising a housing, a ram bar slidably received within the housing, and a floating pickle fork assembly operatively connected to the housing and including spaced prongs, so that the prongs are positioned around the stud of the tie rod end and between the ball joint of the tie rod end and the steering knuckle, and striking the pickle fork with the ram bar. As part of the step of striking, the floating pickle fork assembly moves with respect to the housing.

### BRIEF DESCRIPTION OF THE DRAWINGS

For a full understanding of the invention reference should be made to the following detailed description and the accompanying drawings, wherein:

FIG. 1 depicts a fragmented perspective view of an impact separator tool constructed according to the concepts of the present invention.

FIG. 2 is a fragmented exploded view of the tool of FIG. 1.

FIG. 3 shows an impact separator tool in a first position, such as the position that it may be in before it is used.

FIG. 4 shows the impact separator tool of FIG. 3 in a second position, such as after the ram bar strikes the floating pickle fork assembly.

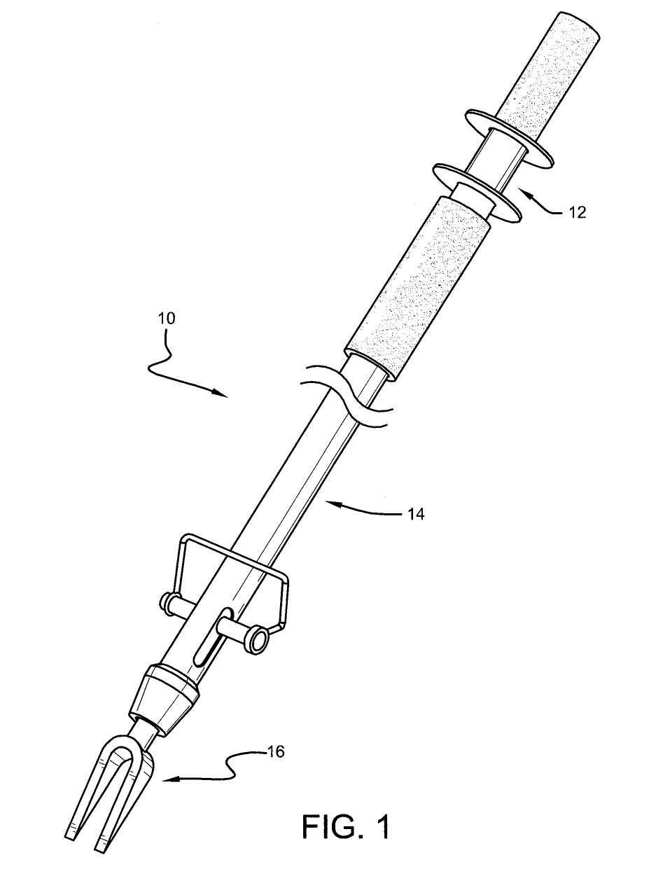

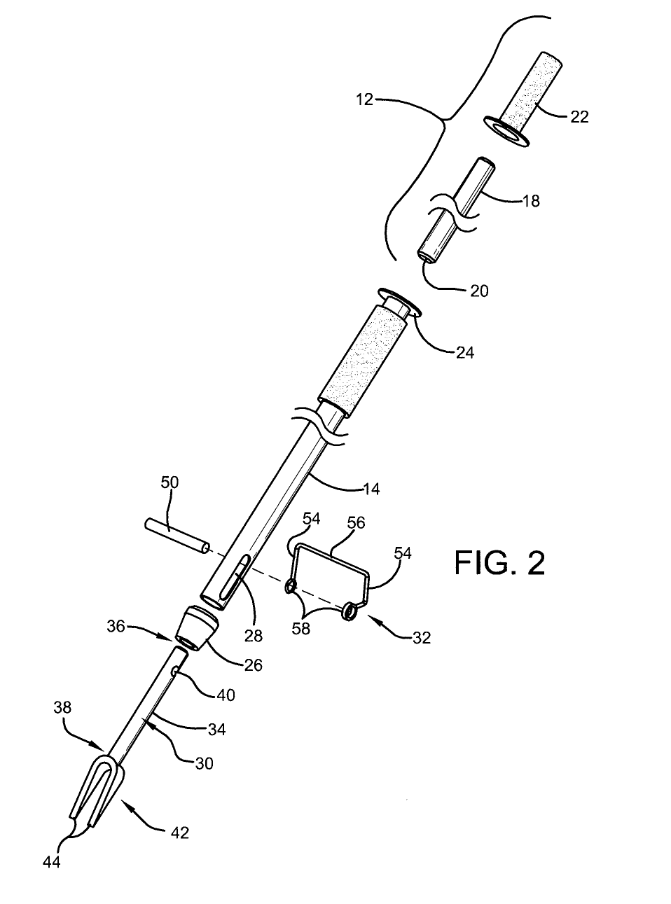

### DETAILED DESCRIPTION OF THE ILLUSTRATIVE EMBODIMENTS

Referring now to the figures, an impact separator tool is shown and is indicated generally by the numeral 10. It includes a ram bar 12, a housing 14 and a working tool, which in the embodiments shown is a floating pickle fork assembly 16.

The present invention may be regarded as an improvement of a slide hammer, and can be used for any useful purpose. In the present disclosure it is described as an impact separator tool, and methods of using it to separate a tie rod end from a steering knuckle are disclosed. However, one of skill in this art area may appreciate other useful purposes for which the invention can be used, notwithstanding the specific context presented herein. In general, a slide hammer is used to strike an item to be struck. In the context of separating a tie rod end from a steering knuckle, the items to be struck include a portion of the tie rod end or steering knuckle (or both), so the description of the impact separator 10 will be presented accordingly. Of course, the present invention may be used for other purposes, but the description of the invention as impact separator tool relates to the purpose of separating tie rod ends and steering knuckles.

Ram bar 12 is used to strike the floating pickle fork assembly 16 and generally includes a gripping end 18 and a striking end 20. Ram bar 12 is typically solid in construction and its weight may be chosen according to the requirements of a particular application. Ram bar 12 may optionally include a gripping handle 22 at the gripping end 18 to facilitate gripping and moving ram bar 12. Striking end 20 may include a beveled edge for aiding the insertion of the ram bar 12 into, and movement within, the housing 14.

Housing 14 receives the ram bar 12 and pickle fork assembly 16 and is generally tubular in construction. Housing 14 extends along a length and has an inner diameter slightly larger than the outer diameter of ram bar 12 so that the ram bar may be received therein and is free to move within the generally lengthwise direction of housing 14. Housing 14 may include a flange 24 near one end and a cap 26 at the other end. Flange 24 provides protection for a user's hand while using the impact separator tool, and cap 26 helps maintain alignment of the movement of the floating pickle fork assembly 16. Slots 28 extend lengthwise along and through the outer wall of housing 14 and are positioned near the end where the floating pickle fork assembly 16 is received.

Floating pickle fork assembly 16 is a working tool used to strike an item to be struck and generally includes a pickle fork 30 and a retaining pin 32. Pickle fork 30 includes a shaft 34 extending from a first end 36 to a second end 38. A through bore 40 extends diametrically through shaft 34 near first end 36, and a wedge portion 42 is included near second end 38. Wedge portion 42 is configured for separating a tie rod end from a steering knuckle and includes spaced prongs 44, each having surfaces that are angled and meet at a tip. Shaft 34 may include a beveled edge near first end 36. While features of a particular pickle fork are disclosed, it will be appreciated that pickle fork 16 could be replaced by other suitable working tools.

Retaining pin 32 interacts with pickle fork 30 and housing 14 to limit the movement of the pickle fork within the housing. It generally includes a dowel 50 and a retainer assembly 52 which has two arms 54 connected by a base 56. Loops 58 are attached to each arm opposite base 56 and engage with dowel 50 to retain a connection and prevent retaining pin 32 from being inadvertently removed.

Impact separator tool 10 is assembled as follows. Cap 26, if present, is fixedly connected to housing 14. Shaft 34 of pickle fork 30 is inserted through cap 26 and into the interior of housing 14. Particularly, first end 36 of shaft 34 of pickle fork 30 is placed through the portion of cap 26 opposite the portion that receives the housing 14. The wedge portion 42 is not inserted into housing 14. Pickle fork 30 is positioned in housing 14 so that the through bore 40 through shaft 34 aligns with slots 28 extending through the outer wall of housing 14. Retaining pin 32 is then installed. Particularly, dowel 50 of retaining pin 32 is inserted through slots 28 and through bore 40, and loops 58 secure the retainer pin on either side of the housing.

Thus, pickle fork 30 is moveable within the limits defined by the interaction of pickle fork 30, retaining pin 32 and housing 14. Pickle bar 30 and retaining pin 32 are moveable with respect to the housing 14, hence their combination is referred to as a “floating” pickle fork assembly. There are no springs used in impact separator tool 10, and the floating pickle fork assembly 16 is free to move within its limits and is not biased to any particular position or in any particular direction.

Ram bar 12 is inserted into housing 14, with striking end 20 generally in contact or able to contact pickle fork 30 and gripping end 18 extending out of the housing 14 opposite the pickle fork 30.

Impact separator tool 10 may be disassembled by performing the assembly steps in reverse order. And because pickle fork 30 is readily separated from the other components of the impact separator tool 10, it will be apparent that other working tools can easily be incorporated into the impact separator tool in its place.

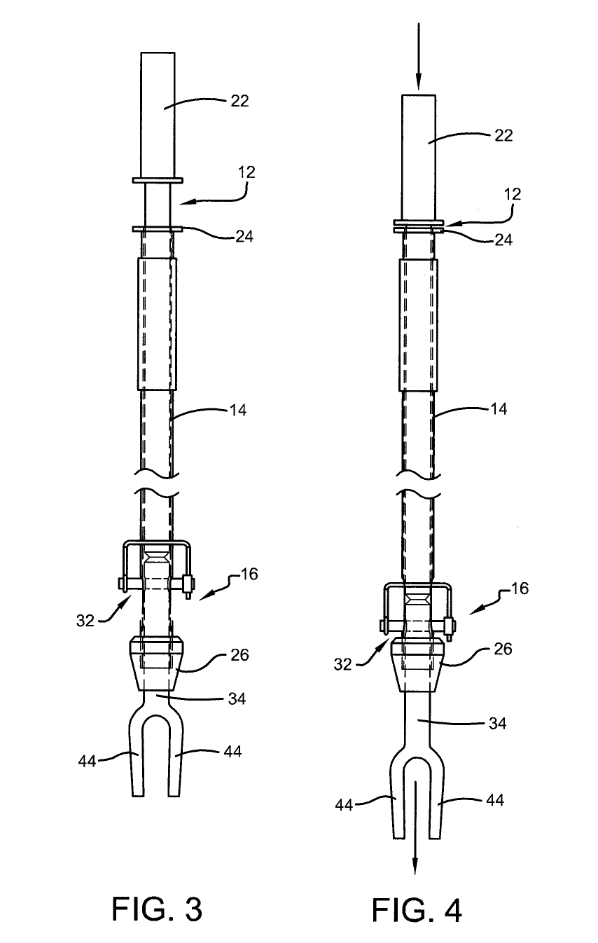

Impact separator tool 10 may be used as follows. A user grasps tool 10 and situates it in an appropriate position with respect to a tie rod end connected to a steering knuckle. In particular, the pickle fork 30 is positioned so the spaced prongs 44 of wedge portion 42 are around the stud of the tie rod end and the angled surfaces of the wedge portion are positioned between the steering knuckle and the ball joint of the tie rod end. Maintaining the housing 14 and ram bar, the user may push along the lengthwise direction of tool 10 to bring the tool into solid contact with the tie rod end and steering knuckle. It also pushes pickle fork 30 into housing 14 up to its maximum extent, which position is illustrated in FIG. 3. In that position, the dowel 50 contacts the portions of slots 28 furthest from cap 26, thereby limiting further movement of pickle fork 30 into housing 14. Holding housing 14 and floating pickle fork assembly 16 generally stationary, the user grasps ram bar 12 (such as at gripping end 18), and withdraws a portion of the ram bar from within the housing. After checking to make sure the pickle fork is still appropriately positioned, the user moves ram bar 12 rapidly toward pickle fork 30 so that striking end 20 of ram bar 12 impacts pickle fork 30 (near first end 36). The energy of ram bar 12 is thus transferred to the floating pickle fork assembly 16, and the wedge portion 42 of pickle fork 30 works to separate the tie rod end from the steering knuckle. Specifically, wedge portion 42 wedges between the ball joint and the steering knuckle and pushes those two components apart until the stud of the tie rod end can be removed from the bore in the steering knuckle.

The dowel 50 and the portions of slots 28 nearest wedge portion 42 limit the forward movement of the floating pickle fork assembly and prevent it from leaving the housing 14. FIG. 4 depicts the impact separator tool in a position where the ram bar 12 has impacted floating pickle fork assembly 16 and moved it the position where its further movement away from ram bar 12 is limited. The arrow in FIG. 4 indicates the direction of movement of the ram bar 12 and the floating pickle fork assembly 16.

Of course, the extent to which a ram bar is moved and the speed and number of times it is used to strike the pickle fork may be determined and controlled by the user.

Impact separator tools constructed according to the concepts of the present invention offer several advantages over prior art forms. For one, a useful tool for separating a tie rod end from a steering knuckle is provided. Such a tool can be used to direct energy to the location of the connection between a tie rod end and a steering knuckle. Thus, indiscriminate striking of the tie rod end and steering knuckle may be avoided. Also, the tool is easily controlled with two hands and does not require a user to manipulate a pickle fork and a hammer independently in separate hands in the same awkward and dangerous way as is known in the prior art. And, since the floating pickle fork assembly 16 is moveable with respect to housing 14, more energy is transferred from the ram bar to the working portion of the tool as compared with slide hammer designs where the working portion is not moveable with respect to the housing.

It is thus evident that an impact separator tool constructed as described herein substantially improves the art. In accordance with the Patent Statutes, only the best mode and preferred embodiment have been presented and described in detail. The invention should not be limited by the drawings or the description provided herein. For an appreciation of the true scope and breadth of the invention, reference should be made only to the following claims.

1. An impact separator tool comprising:
a housing including slots,
a ram bar slidably receivable in said housing,
and a working tool assembly operatively connected to said housing and including a through bore,
wherein said slots and said through bore are at least partially aligned and said working tool assembly is moveable with respect to said housing.

2. The impact separator tool of claim 1, wherein a portion of said working tool assembly is received within said housing.

3. The impact separator tool of claim 1, wherein said working tool assembly includes a working tool having a shaft, a portion of said shaft being received within said housing.

4. The impact separator tool of claim 3, wherein said shaft includes said through bore.

5. The impact separator of claim 4, wherein said working tool assembly further includes a retaining pin, said retaining pin extending through said bore and said slots.

6. The impact separator of claim 5, wherein said working tool includes a pickle fork having spaced prongs.

7. A tool for separating a tie rod end from a steering knuckle, the tool comprising:
a housing,
a ram bar moveable within and slidably received within said housing,
and a floating pickle fork assembly operatively connected to, and free to move with respect to, said housing.

8. The tool of claim 7, wherein said floating pickle fork assembly includes a pickle fork having a shaft having a through bore, and a retaining pin, said retaining pin extending through said through bore.

9. The tool of claim 8, wherein said housing includes lengthwise-extending slots positioned near said floating pickle fork assembly and said retaining pin extends through said slots.

10. The tool of claim 9, wherein said pickle fork further includes spaced prongs.

11. A method for separating a tie rod end from a steering knuckle, the tie rod end having a ball joint arrangement including a stud, the stud being received in a bore in the steering knuckle, the method comprising the steps of:
positioning a tool comprising a housing, a ram bar slidably received within said housing, and a floating pickle fork assembly operatively connected to said housing and including spaced prongs, so that said prongs are positioned around the stud of the tie rod end and between the ball joint of the tie rod end and the steering knuckle,
and striking said pickle fork with said ram bar,
wherein as part of said step of striking, said floating pickle fork assembly moves with respect to said housing.

12. The method of claim 12, wherein said pickle fork assembly further includes a shaft having a through bore and a retaining pin, and said housing includes slots, said retaining pin extending through said through bore and said slots.
